(19) United States
(12) Patent Application Publication
(10) Pub. No.: US 2018/0262095 A1
(43) Pub. Date: Sep. 13, 2018

(54) EcoBlade Rotating Machinery

(71) Applicants: Guifre Tort, San Juan, PR (US); Lionel Orama, San Juan, PR (US)

(72) Inventors: Guifre Tort, San Juan, PR (US); Lionel Orama, San Juan, PR (US)

(21) Appl. No.: 15/913,195

(22) Filed: Mar. 6, 2018

Related U.S. Application Data
(60) Provisional application No. 62/467,867, filed on Mar. 7, 2017.

(51) Int. Cl. H02K 51/00; F04D 25/08; F04D 25/06; H02K 1/27; H02K 7/14; H02K 11/33; H02K 11/215; H02K 11/00; H05B 33/08

(52) U.S. Cl. CPC H02K 51/00; F04D 25/088; F04D 25/06; H02K 1/2793; H05B 33/0809; H02K 11/33; H02K 11/215; H02K 11/0094; H02K 7/14

(57) ABSTRACT

An energy recapturing apparatus for use with a ceiling fan or other rotating machinery includes a housing having a rotatable fan blade assembly. The apparatus includes a combined motor/generator assembly having bifilar coils situated within the housing or interior space. This combined assembly is operatively connected to one or more fan blade assemblies to apply energy to rotate the fan blade assembly when energized. At the moment of rotation, one or more bifilar coils are utilized to generate energy (voltage/current) from the motor, energy that may then be redirected to uses such as illumination and/or energy storage.

### CROSS-REFERENCE TO RELATED APPLICATIONS

This application claims priority to co-pending U.S. Provisional patent application Ser. No. 62/467,867 titled “EcoBlades Rotating Machinery”, filed on Mar. 7, 2017 the disclosure of which is herein incorporated by reference in its entirety.

### PATENTS CITED

The following documents and references are incorporated by reference in their entirety, Quingshan (WO2014023084). Trainque (US Pat. Pub. No. 2013/0038255), Tseng (U.S. Pat. No. 8,093,860), Bolz et al (U.S. Pat. No. 7,812,572), Tsay (U.S. Pat. No. 5,905,322), Hoemann et al (U.S. Pat. No. 4,737,701) and Kouyoumjian (U.S. Pat. No. 1,219,562).

### FIELD OF THE INVENTION

This invention relates generally to energy saving devices and, more particularly, to an apparatus for use as part of a ceiling fan that utilizes bifilar coils to recapture energy by converting the kinetic energy of the fan assembly into electricity and storing it for use upon the next fan activation.

### DESCRIPTION OF THE RELATED ART

Most fans and ventilators used in homes and offices (very common along the tropics) function primarily through the induced rotation of a blade or other form of air moving component coming from an electrical motor. While good, such an approach, of course, fails when the power to the motor ceases. The above operates in a fashion similar to that of illumination before the invention of LEDs, where incandescent and fluorescent lighting requires constant power.

Energy savings and operation during intermittent power conditions has become an important political issue as energy resources globally have become scarce and expensive in some cases. Many people have a desire to save energy to show their own personal environmental commitment as well as to save money. Homeowners are attempting to save on the cost of electricity usage by shutting off lights when not in use, using high efficiency light bulbs, or keeping their homes a little cooler in the winter and a little warmer in the summer.

In contrast, as we see in recent times, LED lights may operate with low duty cycles using batteries and/or solar cells. It would be desirable if even small amounts of electricity used within a home environment could be recaptured for subsequent usage, such as recapturing electricity from a ceiling fan when the fan assembly is deactivated to be used the next time the fan is energized. The proposed solution would operate a fan in an analogous manner. What is needed, is a fan or similar air moving mechanism that can operate off an initial power surge (be it mechanical (wound up), electrical (AC or DC, wall, solar and/or battery) or even human) and primarily coast afterwards.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect the invention is about a motor and generator apparatus comprising a motor and generator (M&G) static assembly that is coaxially mounted to a rotor, wherein said M&G assembly contains one or more bifilar coils, each said bifilar coils containing one or more windings comprising a first magnetizing coil motor winding, and one or more windings comprising a second magnetizing coil having a generator winding, said rotor is rotationally mounted parallel to said M&G assembly, said rotor has a plurality of permanent magnet components located around said rotor's perimeter, one or more of said first magnetizing coils is driven by an input voltage to generate an induced magnetic field for the rotor to rotate with respect to the stator and one or more of said second magnetizing coils cuts through the magnetic lines and generates electrical power. In another aspect, said rotor is disc shaped, said permanent magnet components are located parallel to said bifilar coil central axis and their rotation intersects said coil's core central axis.

In yet another aspect, said rotor has an equal or smaller diameter than said stator. In another aspect, within one or more of said bifilar coils, said first magnetizing coil gauge is different in size from that of said second magnetizing coil gauge. In yet another aspect, a controlling circuit electrically connected with one or more of said bifilar coil's first magnetizing coils that receives control command to control the electrical current phases of said first magnetizing coils, driving said rotor to rotate and build up an inertia, said controlling circuit is also electrically connected with one or more of said bifilar coil's second magnetizing coils and receives the control commands to control and distribute the power detected and received by said second magnetizing coils into electrical power for output and said controlling circuit can detect the position of said rotor's rotation and thereby determines and controls the electrical current phase of each of the one or more bifilar magnetizing coils.

In another aspect, the electrical power output from said controlling circuit electrically drives either an illuminating unit and/or a storage battery. In yet another aspect, said illuminating unit is a Light Emitting Diode and said rotor has one or more fan blades connected to said rotor. In another aspect, within one or more of said bifilar coils, said first magnetizing coil gauge is different in size from that of said second magnetizing coil gauge.

Other features and advantages of the present invention will become apparent upon examining the following detailed description of an embodiment thereof, taken in conjunction with the attached drawings.

### BRIEF DESCRIPTION OF THE DRAWINGS

FIGS. 1-2 show illustrations of ceiling fan and components, according to the Prior Art.

FIG. 3 shows a exploded isometric view of the EcoBlade motor and generator, according to an exemplary embodiment of the invention.

FIG. 4 shows a side view of the EcoBlade motor and generator, according to an exemplary embodiment of the invention.

FIG. 5 shows an isometric view of the EcoBlade motor and generator, according to an exemplary embodiment of the invention.

FIGS. 6 and 21 show bifilar coil details, according to an exemplary embodiment of the invention.

FIG. 7 shows a control circuit for the EcoBlade, according to an exemplary embodiment of the invention.

FIG. 9 shows a bottom view of the EcoBlade motor and generator, according to an exemplary embodiment of the invention.

FIG. 10 shows details of an electric circuit, according to an exemplary embodiment of the invention.

FIGS. 11-12 show optional fan blades, according to exemplary embodiments of the invention.

FIGS. 13, 15 and 16 show details of an electric schematics, according to exemplary embodiments of the invention.

FIGS. 14, 17-20 show details of graphics from the system performance, according to exemplary embodiments of the invention.

FIG. 22 shows a side view of the EcoBlade motor and generator with purely magnetic coupling for motion of the rotor, according to an exemplary embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

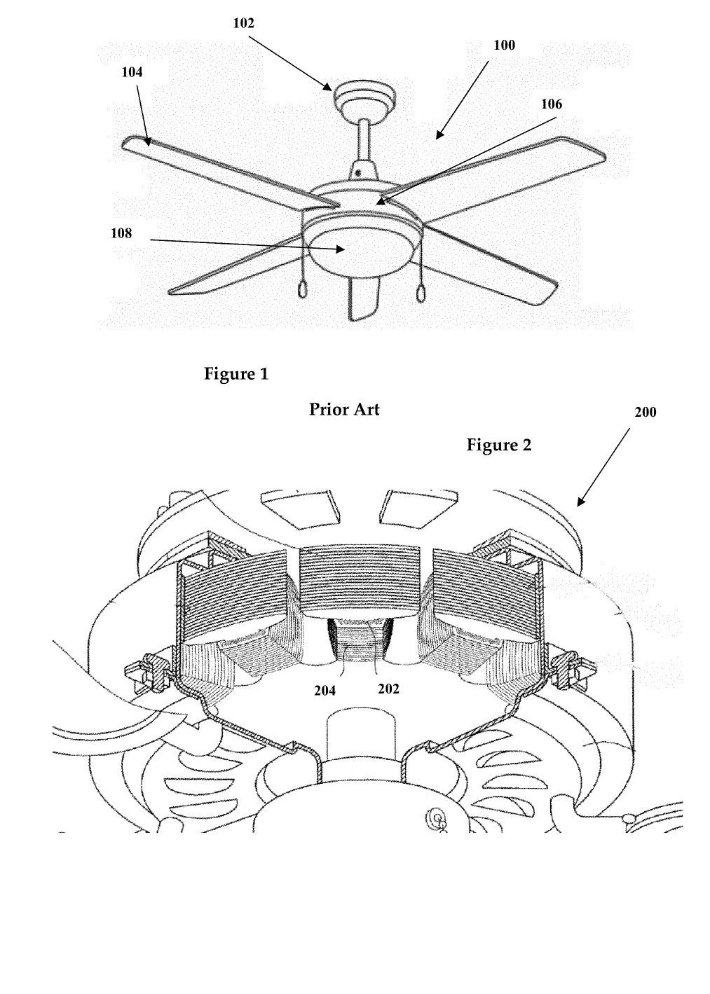

Referring to FIG. 1 we see the prior art of a ceiling fan 100, typically containing a mount 102 which mechanically connects to a hub 106 housing the fan motor that rotates the one or more blades 104, with a usual illumination source 108. The motor is typically electrically operated and controlled in speed. Most if not all AC/DC motors operate through the generation of a magnetic field, which over time and distance results in losses, as this field is wasted. As shown by the prior art, many have tried the use of secondary coils to ‘collect’ this secondary magnetic field, with Tseng (FIG. 2 Prior Art) being one of the best.

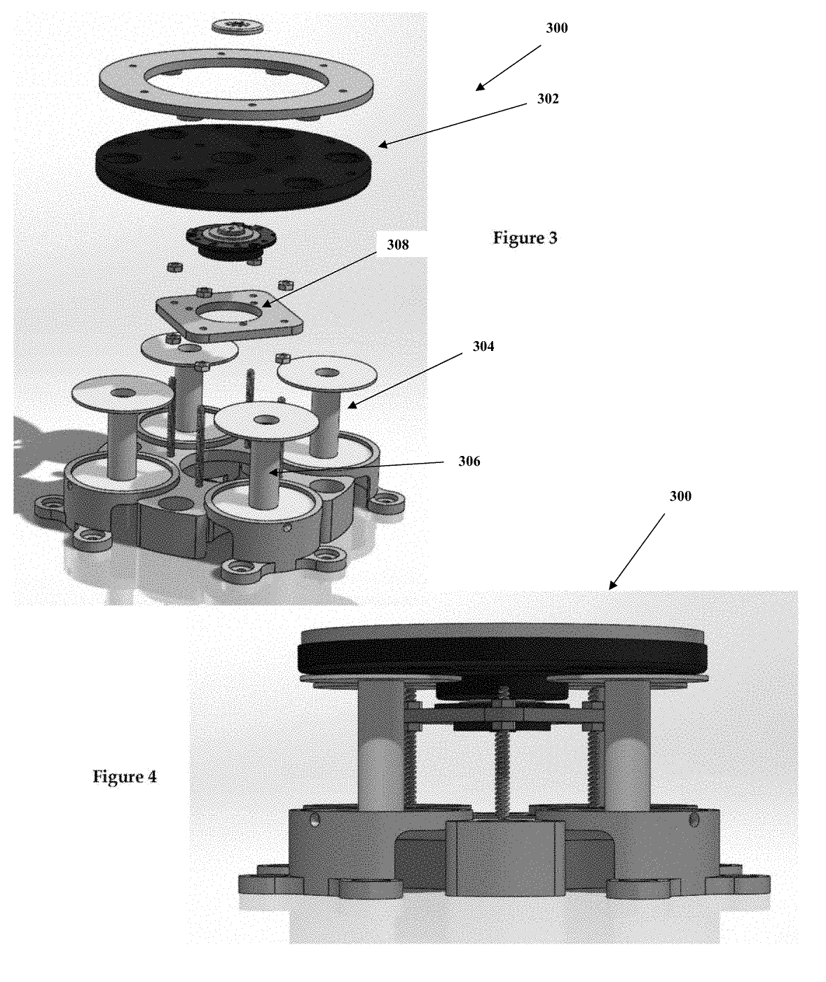

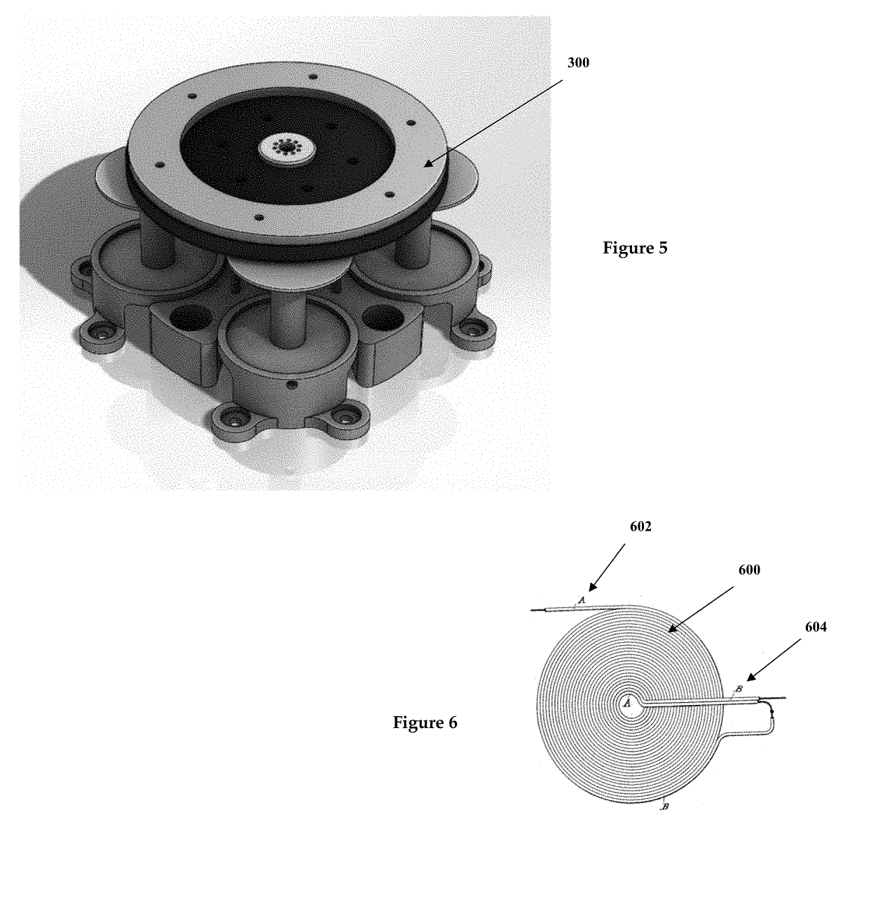

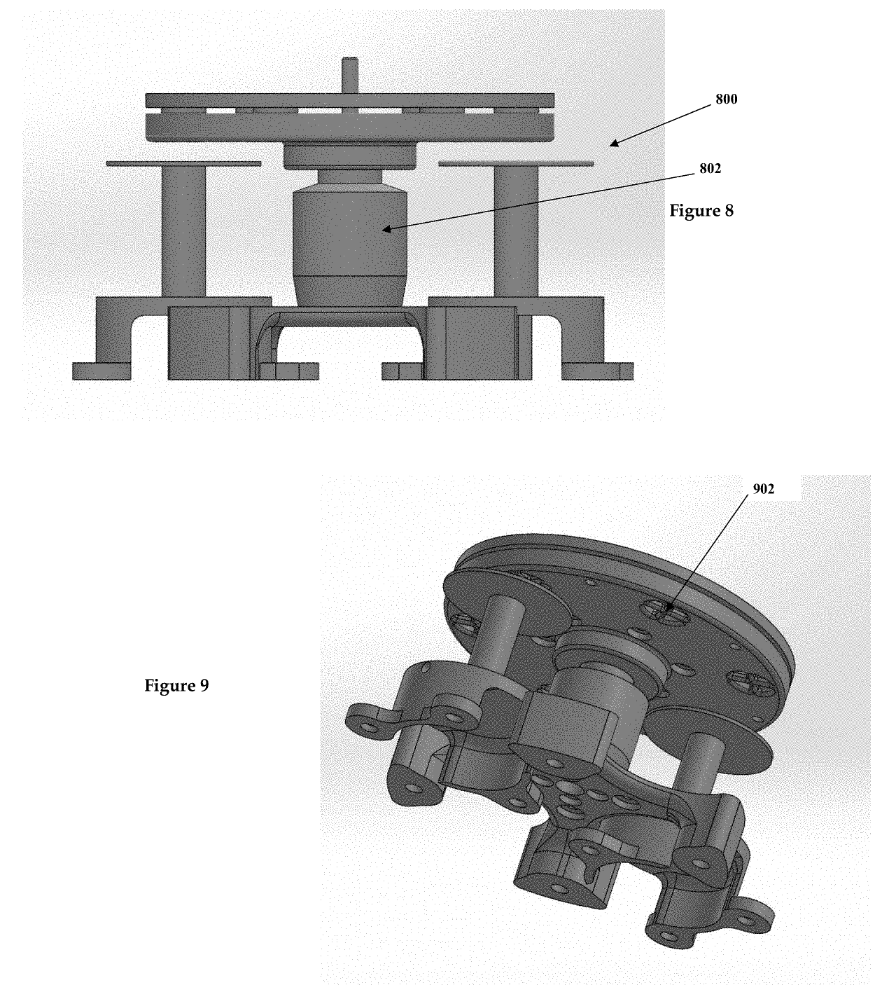

Co-location as shown 200, however, the simple co-location of coils 202/204 is sub-optimal, and may be improved through different component locations to those of the well-known and traditional electric motor 200. In addition, additional information and sensors create an optimal electronic control for the unit, resulting in significant power savings. As seen in FIGS. 3-6, in an exemplary embodiment of the EcoBlade system. To begin with, we see a motor and generator assembly 300 having a top rotor 302, mounted atop one or more bifilar coils 304. The complete assembly 300 is as seen compact. The bifilar coils 600 are comprised of two closely wound cables (602/604). In FIGS. 8-9 we see an embodiment 800 with an optional starter motor 802 and details of the rotor 302 permanent magnets 902.

The unit may be built with two or more bifilar coils 304. Primary 602 and secondary 604 stages of windings are connected in parallel with those of other coils 304. This results in the doubling the output power generated and speed of rotor disc, while at the same time reducing heat loss.

Notice that the connection between the motor/generator components and the rotor (whether connected to fan blades or simply rotating) may be direct to the assembly 308, or through (FIG. 22) the assembly's 2200 connection to an outer housing 2202 (to which the rotor 302 is mounted) and which itself is either attached to the motor/generator through it's own connection and/or an outside frame 2204 that may connect to the outer housing 2202 or through an outside frame.

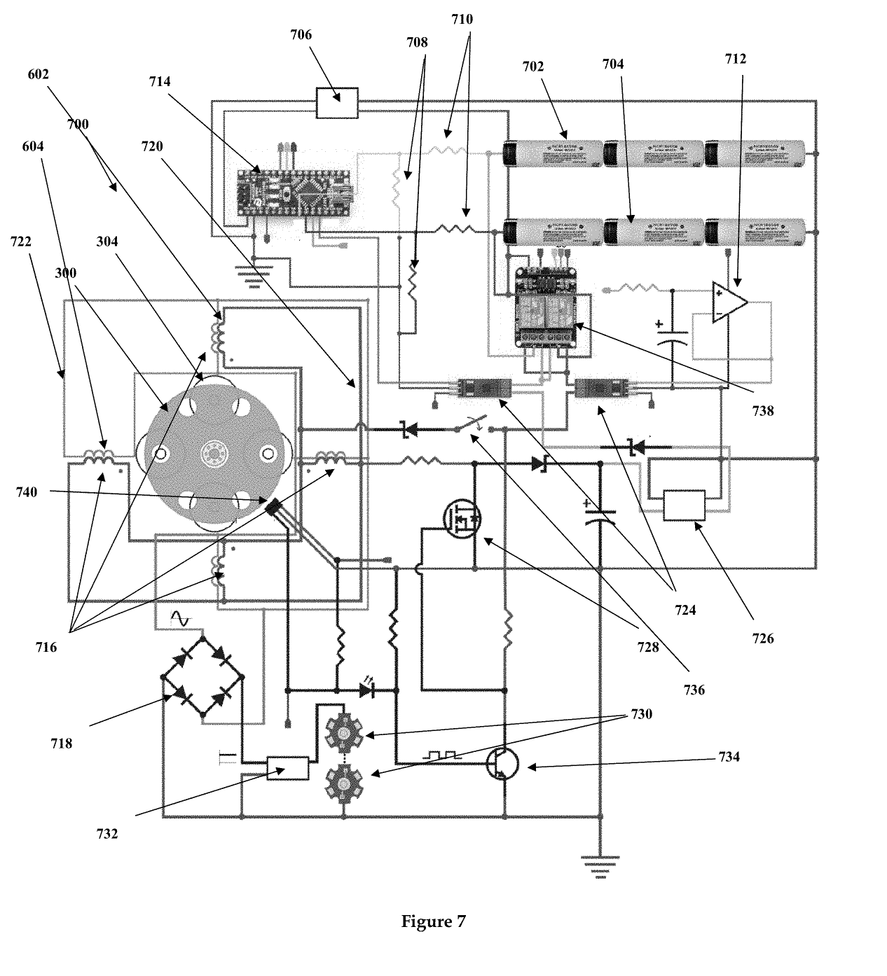

In one embodiment, the circuit 700 in FIG. 7 controls the operation of the unit. The primary components within the control circuit 700 are a power source 702 (which may be comprised of one or a combination of batteries, solar cells, line power and/or external power sources), optional power storage components 704 (also potentially batteries), a step down DC/DC converters 706/726, resistors 708 (100 kOhm), 710 (1 MMOhm), a low pass filter 712 (with an ancillary R/C of 100 Ohm/10 microFarad), in one embodiment), a CPU 714 (in one embodiment and Arduino Nano/Atmel328), the inductor winding 716 formed by the bifilar coils 304 windings 602/604, a Full wave rectifier 718, a primary coil circuitry 720 (in one embodiment 900 turns of 22 AWG coil gauge), and a secondary coil circuitry 722 (in one embodiment 900 turns of 26 AWG coil), Hall Effect linear current sensors 724, a MOSFET Logic Level Driver 728, LED or other light sources 730, their ancillary driver 732, as well as another driver 734 (a BC337 in one embodiment), a switch 736, a relay battery switch 738.

In recent years, DC technology has become more sophisticated to the extent that it can be applied to both residential and industrial ceiling fans. There are several ceiling fans on the market that use brushless DC or BLDC motors. Common DC motors use permanent built-in magnets to attract and repel a rotor around an axis. The biggest drawback of these motors is that commutation is achieved internally via stationary magnets which are susceptible to wear with time. BLDCs on the other hand are commutated externally via sophisticated electronics and require advanced electronics to control speed. Although they are more expensive and complex, they do provide more efficiency and are whisper-quiet.

For instance, a DC fan uses 70% less energy for the same airflow than a conventional AC fan. They are lighter while producing the same power as standard motors. Most conventional fans use AC single phase induction motors that can be controlled by voltage via TRIACs, frequency via Variable Frequency Drive or by phase control. Although these motors work very similar to BLDCs, they often tend to absorb lots of power and waste it by turning it into heat.

Today, all hybrid cars are powered by DC brushless drives, with no exceptions. Segway, electric bicycles, hardrives, PC fans, RC cars and planes, all use BLDCs. A brushless DC motor is mainly an alternator. It uses a special driver circuit that times a DC current through several electromagnets and provides AC power that is in phase with the rotation. In an out-runner BLDC, the rotor is a permanent magnet that rotates around the different electromagnets or poles.

In one embodiment, a single solenoid or single coil electromagnets. The biggest fault to using single coils is back-EMF. The transistor constantly pulses ON and OFF the coil, but when a solenoid is turned ON it slowly builds up current and stores kinetic energy as magnetic flux. The coil is essentially functioning as a load. When this kinetic energy reaches a maximum value and then the coil is switched OFF, the magnetic flux collapses and the polarity of the component changes as to deliver an opposite voltage, called back EMF. With single coils this back-EMF is lost and not put to use.

Bifilar coils 304 include two set of wires 602/604 which may have equal and/or different gauges wound up together. Making the primary 602 different gauge achieves a sink effect where it allows the back-EMF to flow through the second coil 604 and can be put to use recharging a battery or illumination. These types of coils also reduce space of the system and parts which increases efficiency. Thicker wires (smaller gauges) have been found optimal for current flow.

In the EcoBlade the electromagnets (coils 304) are placed below the rotor, preferably so that the permanent magnets 902 are lined up to the bifilar coil core 306 center. In this fashion, and as opposed to the “over the top” traditional placement FIG. 2, a much more narrower rotor arrangement can be accomplished, where the rotor 302 may be as narrow as the stator 2206.

cross over the center of the working as a sort of Bedini SSG setup. Essentially this is a BLDC inside of another BLDC. This alternative way of power generation helps power batteries and or produce lighting without wasting any space or energy. Inductance is an electromagnetic phenomenon in which a change in current flowing through a wire induces an electromotive force in the conductor itself and in nearby conductors by means of mutual inductance. Therefore, the magnetic field produced in one winding is equal and opposite to that created by the other, resulting in a net magnetic field of zero. This will have the effect of neutralizing any negative effects in the coil by suppressing unwanted back-emf.

In one embodiment, coils 304 were wound to about 600 turns using a simple homemade winder with 26 AWG wires for pickup coils (coils that generate) and 22 AWG for pushing coils (coils that push magnets on rotor). The magnetic field is concentrated into a nearly uniform field in the center of a solenoid. An iron core 306 was introduced to these solenoids. Inserting an iron core has the tendency of multiplying the inductance of the solenoid significantly.

In one embodiment, a mixture of iron fillings and super-glue was prepared on the core to maintain the fillings in place. Tests before and after adding the iron core reveals that inductance was duplicated whereas induced voltage (voltage generated on pickup coil) was doubled. In addition, losses in the form of heat on the coil were diminished which resulted in more efficiency.

To improve fast switching, reliability and efficiency a MOSFET Logic Level Driver 728 (in one embodiment the IRLB3034) MOSFET, is used, optimized for Logic Level Drive. This offers a very low RDS (on) of 0.0014 or 1.4 m Ohms at 4.5 Threshold Voltage. In an alternate embodiment, a Reed Switch (OMR-C-105H) to detect the rotation of the rotor and trigger the state of the transistor. Reed switches are essentially relays or electrical switches that depend on a magnetic field induced on a coil to close and complete a circuit. On the contrary, hall sensors are solid-state devices and are rated with an unlimited lifespan which make them suitable for motor control applications. They also offer signal-processing electronics already integrated which means no additional circuitry is needed to operate them. One such embodiment would be the use of a Hallogic Hall-effect sensor 740 (such as a OH090U).

In one embodiment, a brushless DC motor (BLDC) rotor 802 may be used as a mount for the rotor 302. The purpose of this implementation was to take advantage of the unused space around the axis of the shaft and the mechanical advantage of a rotating motor which acts as a generator. A drawback of this particular BLDC is that it includes a big inner bearing and magnets for each pole, which gives the rotor more weight and resistance at the time of rotation.

In one embodiment, the rotor 302 has double N52 axially magnetized neodymium magnets 902, typically in an alternating N-Polarity/S-Polarity configuration, N-N-P-P and other such combinations may be possible and driven through the coil 304 magnetizing. Axial magnetization permits solenoids to be placed in parallel (or standing) to axis of rotation. This setup reduces overall size of system. These magnets 902 offer a pull force of approximately 10 lbs. which is about double from previous ones. When two magnets are united this force duplicates.

Given that EcoBlade's deals with motor applications, power is a big factor. Motors tend to operate with low voltages but yield high currents depending on the load. Essentially there are two sides to the system. The high-power side of the circuit 700 connects the power source 702 and the one or more pushing coils 304 (connected to the 720 circuit) with the drain of the transistor and the low power side 722 that connects the gate of the MOSFET to the microcontroller 714. Part of the job of the MOSFET is to isolate both of these parts so that the microcontroller portion does not get ruined by the high currents of the transistor.

In one embodiment, the schematic 700 offers sensors to measure RPMs and power consumption for the benefit of the user. In addition to transparency, this data can be further processed to build a smarter control system that regulates power and switches different parts of the system on demand. RPM sensing is achieved through the Hall effect sensor 740. This transducer counts the number of times the magnet passes through the sensor and triggers an algorithm that converts the counts to revolutions per minutes. The CPUs 714 built-in timing function stores frequency which helps to calculate speed.

Input current is measured with Hall Effect Linear current sensors 724 (in one embodiment an ACS712). This sensor provides a 2.1 KVᵣₘₛ voltage isolation and a low-resistance current conductor. The output is read via the CPUs 714 analog pin. Given that the MOSFET switches ON and OFF depending on the position of the rotor means that the signal driving the transistor is a square wave. Some measuring issues arise when measuring current through a pulse modulated signal because the sensor reads both HIGH and LOW states which brings inconsistencies in the readings.

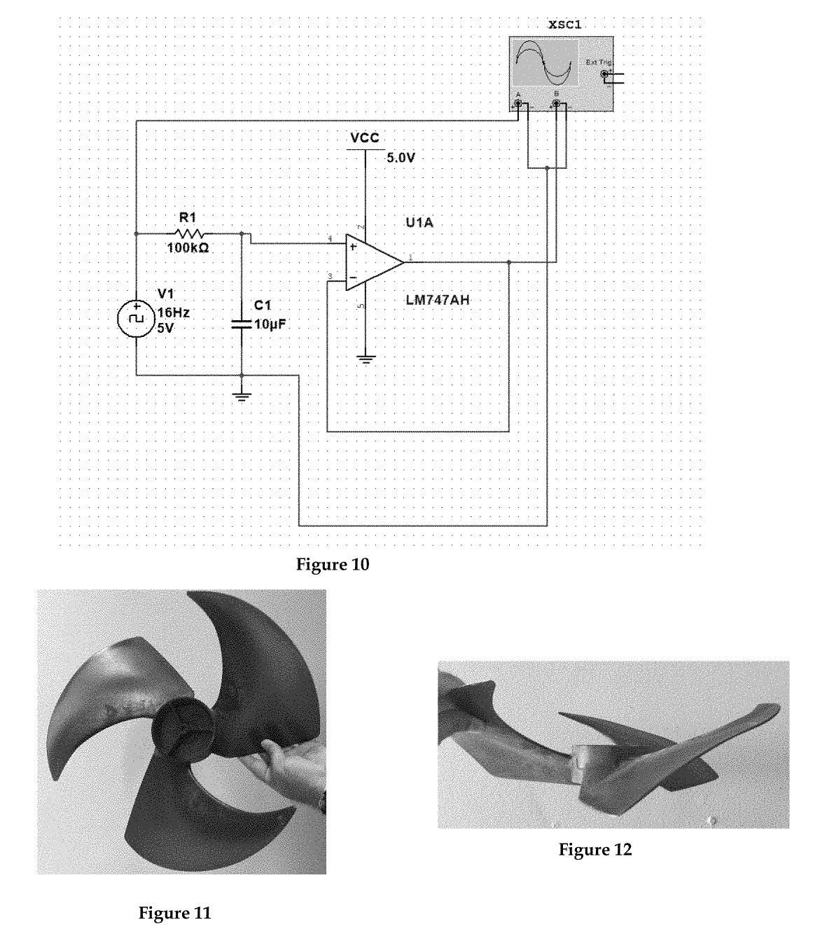

In one embodiment, a Low-Pass filter may be implemented. FIG. 10 shows detail of the circuit used the circuit used 712. Low-Pass filters are ideal for this application because they pass signals with a frequency lower than a certain cutoff frequency and attenuate frequencies higher than this cutoff. Using the cutoff frequency equation with this value, the RC constant was determined in order to design the filter with available components.

Input voltage is measured through a simple voltage divider circuit. CPU 714 analog inputs can be used to measure DC voltage between 0 and 5V. The range over which the CPU 714 can measure voltage can be increased by using two resistors. The voltage divider decreases the voltage being measured to within the range of the Arduino analog inputs. With input voltage and current power can be calculated by multiplying both values and displayed accordingly.

In one embodiment, the display used is an I2C Serial 20×4 LCD module. The beauty of this display is that it includes a communication device on the back that converts all power and digital inputs, which are over 16 to just 4 pins, via an I2C protocol that essentially uses only two analog pins (SCL and SDA) to communicate with the microcontroller. This greatly reduces programming, power consumed and memory storage space of the microcontroller.

Electrically starting the circuit is due in part because as the hall effect sensor is solid state and doesn't suffer from the drawbacks of back-EMF noise (as do others, like reed switches). Hall sensors use back-EMF to their advantage to trigger a signal on the output.

In one embodiment, a full wave rectifier is implemented in order to convert AC into DC power on the output of the pickup or generation coils. Bridge Rectifiers 718 (GBU4A for example) are used to achieve this capability. A smoothing capacitor can be used was used on output of rectifier to reduce undesirable ripple caused by AC. In another embodiment, a three-phase full wave rectifier circuit may be used in order to convert triphasic AC into DC useful power. Up to six 1N5820 Schottky diodes were used to achieve this. A smoothing capacitor is used on output of rectifier to reduce undesirable ripple caused by AC.

In one embodiment, DC/DC boost converters 706/726 (such as the Adafruit's PowerBoost 1000C module) can be powered by any 3.7V Lilon/LiPoly battery, and convert the battery output to 5.2V DC for running 5V projects. It achieves this with its built in TPS61090 boost converter from TI. Weight is both a necessity and a drawback, necessary given that torque is a factor on the design of any flywheel or spinning disc. If a spinning disc is too lightweight (mass is too low) the moment of inertia will be too low and thus torque will be too low. This is an important factor in the design of a ceiling fan because rotating paddles must have enough torque to circulate air. Otherwise, drag or air resistance will be too much for system to handle and circulation will not be achieved. FIGS. 11-12 illustrate optional fan blades.

Ceiling fan manufacturers measure efficiency with a rating called efficacy. It is given in cubic feet per minute of air movement per watt of electrical power input (cfm/watt). Generally, the norm is that larger fans have higher efficacies. That's not the only factor, of course, but all else being equal, efficacy increases when you increase the blade length. Fans use a motor that causes the blades to move through the air. Because of the way they're slanted with respect to the plane of rotation, they push air. To get more air movement, you can do two things: Increase the fan speed or increase the blade size. Both increase the energy usage, but increasing the fan speed increases the energy usage a lot more than increasing the blade size.

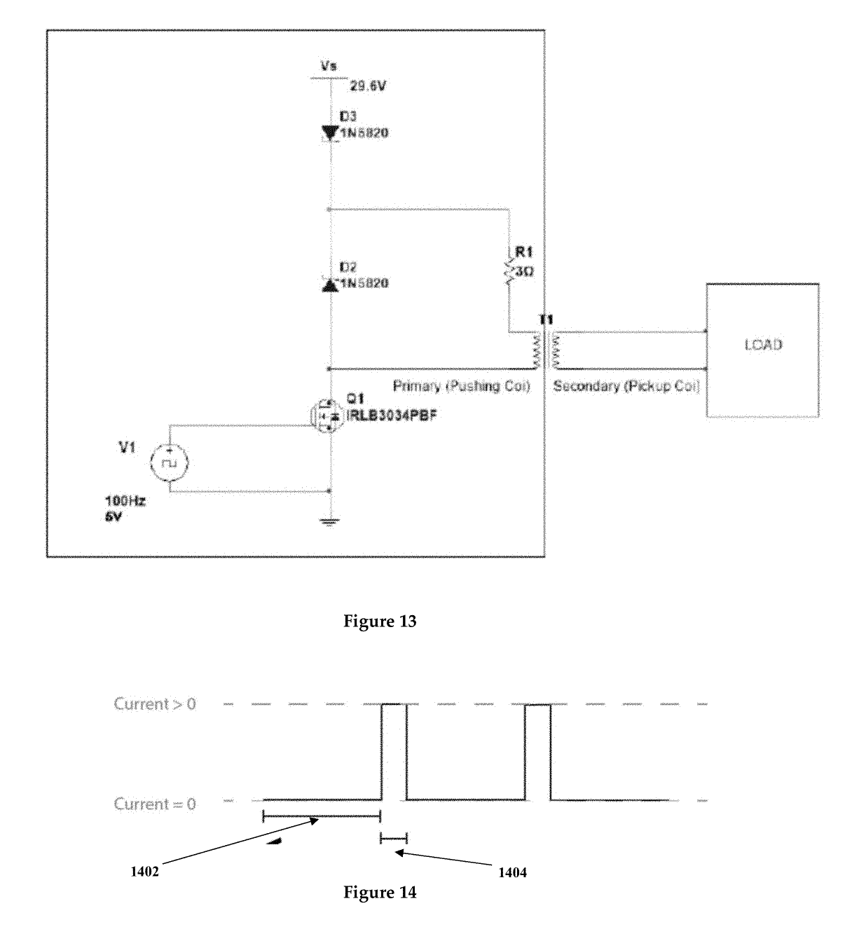

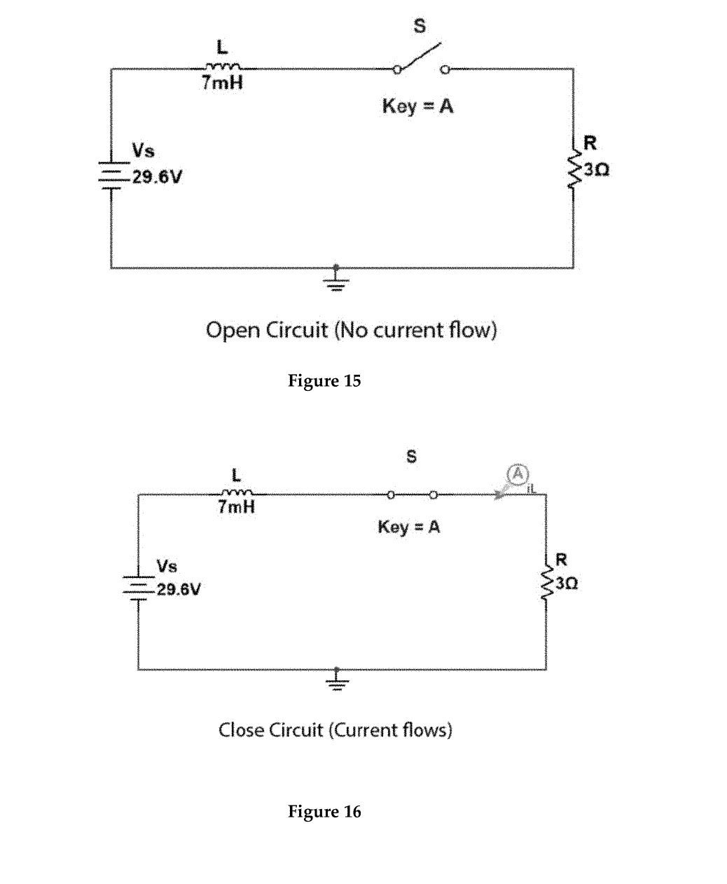

In order to better understand and estimate the EcoBlade system's power capabilities, further explanation of their utilization model is necessary. The top block of FIG. 13 shows one embodiment of a circuit used for driving the pushing or primary coil (304), i.e. the coil moving the rotor 302. FIGS. 15-16 show a basic RL circuit which consists of a power source Vs, inductor L and a resistor R. They are switched on and off by a switch S. This simple circuit is used to explain the operation of driving the pushing coil and will serve as an approximated model. The resistor R represents heat dissipated by the windings of the coils and other losses associated with the diodes and battery's internal resistance and switching losses of FET transistor.

To illustrate operation switch S represents the transistor. When S is open, no current will flow through circuit loop. This cycle is illustrated FIG. 14 as subinterval 1402 by graph on the middle and works according to left circuit. This state represents when the Hall sensor is in a HIGH or in an OFF state. This sensor is used to detect magnetic fields induced by magnets on disc and hence trigger state of transistor.

When Hall sensor picks up a close magnetic field with the rotation of the disc it triggers a LOW or ON state which causes S (transistor) to complete the circuit, 1404. In this state, a current is formed which is dissipated by previously mentioned losses but more importantly, some of this energy is stored as a magnetic field in the inductor. This magnetic field, not only acts to create a magnetic force that pushes the rotating disc, but some of it is recycled through the secondary winding of the bifilar coil used. This recycling will mostly happen in 1402 where coils are not storing but delivering this stored energy. Inductors act as batteries after they are disconnected from a power source which enables them to deliver this energy back. Most times, this energy is loosed as heat, but by using a bifilar coil, this current can be channeled and converted to useful power like it has been discussed.

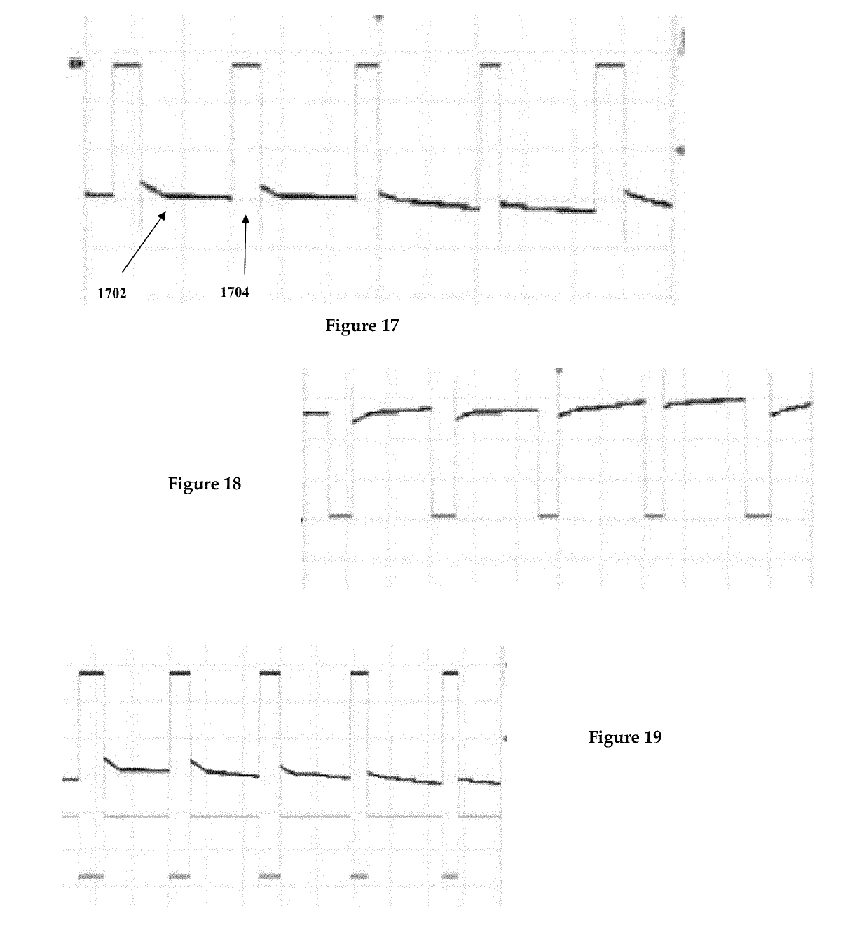

This constant switching can be visualized with FIG. 17, an image captured by an oscilloscope. This unfiltered signal has the shape of a pulsed square wave with a frequency (F) and a duty cycle (DC). Some of these measurements can be seen in previous section. Duty cycle is an important parameter to consider for pulsed signals because it uncovers how much time in a period T a given signal is OFF or ON. For instance, the signal shown has peaks which are narrower and valleys which are wider. The narrow parts are the states associated with subinterval 2 while the valleys represent those associated with subinterval 1. It Is evident that subinterval 1702, or the state when the switch is OFF, covers about 80% of the whole period T while subinterval 1704 covers the rest of about 20%. This shows that the circuit is operating at an average input power rather than at a constant DC source.

It may appear that this signal acts as a pulsed-width-modulated or PWM source. However, signal shown on FIG. 18 was inverted prior to capturing it with scope for the purpose of clarity. The actual signal is shown in FIG. 19. This signal can become misleading because it seems like the system operates at the wider parts, which would make the duty cycle the undesirable value of 80%. However, as previously explained, transistor turns ON when Hall sensor is LOW which enables current to flow only on the narrower parts of the signal. As soon as the transistor switches on, the voltage drops down to zero because it is shorted to ground, and this allows a current to flow.

On the wider parts, the voltage is on but there is no current flowing from power source through circuit (there is actually current flowing but from the other direction due to back-emf but most of it is recycled) so power is essentially zero. Only when Hall sensor voltage (green) is LOW then the transistor (blue) turns on and conducts current. But what is important is not the voltage but the duty cycle which averages at about 20%.

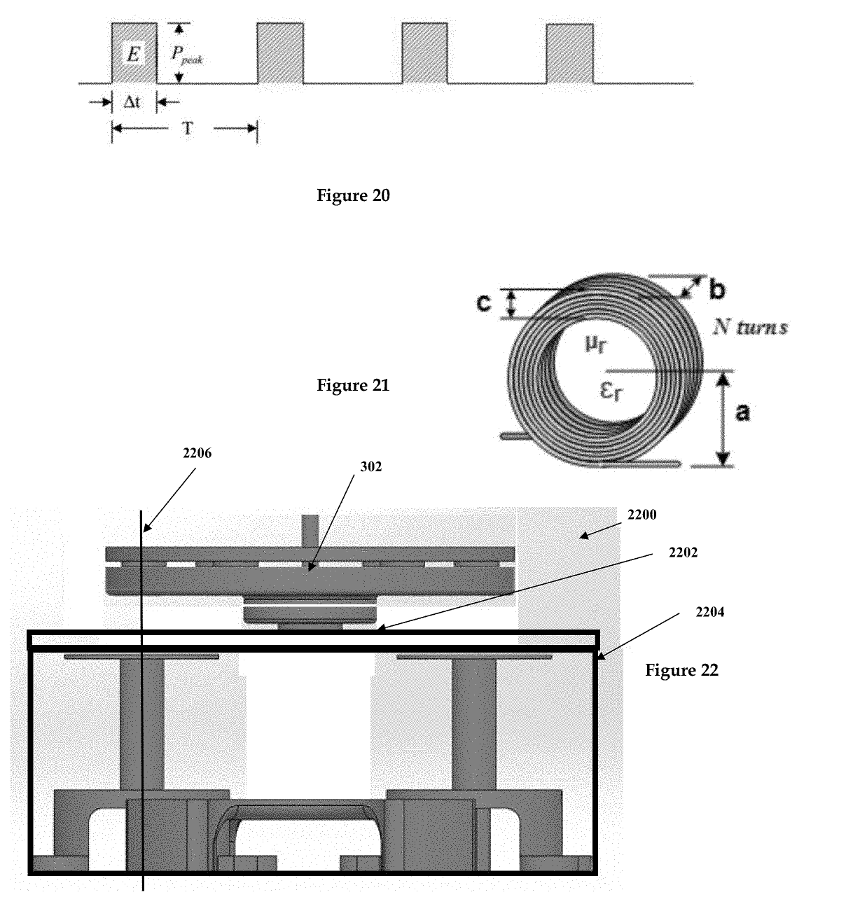

FIG. 20 shows a common pulse width modulated (PWM) signal with T representing one period or cycle, Δt representing the period of one pulse, Pₚₑₐₖ representing the amplitude or peak power and E representing Energy. As can be noted, Energy is the area under the curve. The following equations define how to calculate the average power.

Pₚₑₐₖ is defined as the rate of Energy flow in every pulse

$${P}_{peak} = \frac{E}{Δ t}$$

P_{avg} is defines as the rate of Energy flow in every full cycle

$${P}_{avg} = \frac{E}{T}$$

By solving for E one can equate the following relationship between previous parameters and define what has been previously discussed as Duty Cycle or DC:

$$Duty Cycle = \frac{Δ t}{T} = \frac{{P}_{avg}}{{P}_{peak}}$$

Knowing that power of the resistor R on the right circuit can be calculated with the following formula:

$${P}_{R} ( t ) = \frac{{V}_{R}^{2} ( t )}{R}$$

And knowing that Pavg can be found by integrating the power consumed by resistor R in one full cycle with the following:

$${P}_{avg} = \frac{1}{T} {\int }_{0}^{T} {P}_{R} ( t ) dt$$

Substituting the formula for power with the inner parameter of the integral we get the following:

$${P}_{avg} = \frac{1}{T} {\int }_{0}^{T} \frac{{V}_{R}^{2} ( t )}{R} dt$$

It is interesting to note that more of half of the power or about 60% of the power is consumed by the coil winding resistance, a drawback of having large coils with many windings and air cores. The cyan block shows the average power delivered to a load of 40 Ohms which represents our battery charger portion. When output and input average powers are divided efficiency of system can be calculated by:

$$Efficiency = \frac{{P}_{out}}{{P}_{in}} * 100 \% = \frac{5.77 Watts}{20.6 Watts} * 100 \% = 28 \%$$

The self-inductance, mutual inductance and efficiency of a bifilar coil differs from that of common coupling coils like the ones of an ideal transformer. In addition, primary and secondary wire gauges are different. Also, the inductance of the coils which is approximately 0.007 Henrys is still too low. The following figure demonstrates why.

$$\underline{Wheeler ' s} Formula \text{:} L = \frac{0.8 \cdot {a}^{2} \cdot {N}^{2} \cdot {μ}_{r}}{6 \cdot a + 9 \cdot b + 10 \cdot c} [ in , μ H ]$$

As seen in FIG. 21 using Wheeler's formula an approximation of an air core multilayer coil can be achieved. By substituting the dimensions of the coils (a, b, c) and the number of windings N used, equation yields 6.64 mH. Note that this value was calculated by assuming that the relative permeability or μᵣ is equal to 1 because the coil uses an air core. If an iron core was implemented the inductance could be raise to a factor of a thousand. This is 0.007*1500=10.5H. Another simulation with the inductance of the coupling coils set to 10.5H. It is evident that this change doubles the efficiency to about 61%:

$$Efficiency = \frac{{P}_{out}}{{P}_{in}} * 100 \% = \frac{9}{14.6 Watts} * 100 \% = 61 \%$$

In one embodiment, the approach taken so far has been to increase the turns to about 900 in order to greatly influence the inductance. In order to multiply this inductance by a factor 1000, a core of a high permeability material such as iron may be used.

It has been demonstrated that the circuit functions as to appropriately drive a power transistor that in turn drives an electromagnet or coil which pushes a rotating disc while at the same time recycling part of this energy stored in the inductor back to a load that can be lighting or a charging battery. However, after several measurements with different configurations of coils and a simulation, it has been determined that the factors that are most affecting the efficiency of the system are the current electromagnets used. The more power generated on the output means that the batteries can be charged faster and/or the illumination LEDs 730 powered by the secondary winding 604/722 shine with more intensity.

Using an iron core material for the coil center 306 can greatly increase the inductance of the coil, but another factor arises: iron is ferromagnetic. This means that it gets attracted to nearby magnets such as the strong neodymium ones used in the rotating disc. This will be counterproductive when more than two coils are used because they will provide unwanted resistance in the rotating disc. So all the coils will be pushing and pulling the disc at the same time which will diminish overall efficiency. This can be fixed by implementing a maximum of two coils. For instance, one can be used to charge a battery, and another can be used for lighting. However, fewer coils means more windings, bigger area and lower length. Similarly, the coil centers 306 may be made of non-ferrous materials (plastic, aluminum, copper, etc.)

In one embodiment, a Double Battery Setup 702/704 that has been proposed for this project. The idea with this setup is to extend by a factor of x, the life of two batteries by constantly switching charging and discharging between the two of them. The higher the efficiency to 100% (to 1) means that the source battery will discharge, and the load battery will charge in a balanced way. Otherwise, with a low efficiency, such as 28% means that the source battery will discharge at a rate faster than the charging battery. In another embodiment, Photovoltaic technology may be considered as the power source 702.

In one embodiment, a new configuration capable of self-starting, running at a constant speed and charging bigger battery packs at a low power of 20 Watts. It is important to note that the output charging battery adds a significant amount of load to the system. This load can be viewed as a sort of brake on the motor which reduces speed and increases power consumption. Under no load conditions (no battery charging) the system is able to self-start and run continuously for as low as 9 Watts while also powering high intensity LEDs at a negligible current draw.

In one embodiment, a strength of the EcoBlade lies in a no-load environment, requiring a lower power to rotate the rotor disc while making possible charging of lower powered batteries such as the one from a smartphone and providing lighting at a negligible power cost. In addition, both battery packs from the DBS can be connected in parallel to form a Li-Ion configuration of 3S2P which will double the capacity and hence the time of operation of system in one charge. This could be very suitable for outdoor applications, where the system can be charged by plugging it to the wall or from a solar panel input.

In another embodiment, the batteries are not installed, and the system is an in-grid device like a common household fan. A transformer can be added in order to convert AC to DC and power the system from the grid at an appropriate rating. The differentiator to any fan on the market would be that EcoBlade runs at a lower power than any fan currently on the market which yields power savings for the consumer.

In one embodiment, the invention is a super-efficient motor which consumes power from the grid (AC or DC, say 12 volts off the grid), from alternative energy sources (Solar/PV cells, Wind Turbines and/or others), at the same time having a series of Air Core Magnets or windings which capture the energy generated by the rotation of the permanent magnets over them. That is, a motor which is also generating power. This power is stored in batteries for later consumption in light sources and/or on re-starting the fan motor when it stops or is turned off. Such a motor requires grid energy to either start or to maintain movement.

In another embodiment, the fan motor starts with an external mechanical force (say a human rotating the blade and/or crank), and the Hysteresis effect movement uses the energy stored within the rotor's permanent magnets to continue the fan rotation. Simultaneously, a series of Air Core magnets (i.e. windings) capture the energy generated by the rotation of the permanent magnets over them. In essence, the motor also generates energy. Said energy is stored within batteries and may be used later for lighting and/or to restart the motor once it stops. Said battery storage and/or human start means the unit does not require any grid energy to start or maintain its movement. In essence, it is using the energy within the magnets to start and maintain its movement, using the additional energy for lighting and/or starting.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

1. A motor and generator apparatus comprising;
a motor and generator (M&G) static assembly that is coaxially mounted to a rotor, wherein said M&G assembly contains one or more bifilar coils, each said bifilar coils containing one or more windings comprising a first magnetizing coil motor winding, and one or more windings comprising a second magnetizing coil having a generator winding;
said rotor is rotationally mounted parallel to said M&G assembly, said rotor has a plurality of permanent magnet components located around said rotor's perimeter;
one or more of said first magnetizing coils is driven by an input voltage to generate an induced magnetic field for the rotor to rotate with respect to the stator; and
one or more of said second magnetizing coils cuts through the magnetic lines and generates electrical power.

2. the motor and generator apparatus of claim 1 wherein;
said rotor is disc shaped;
said permanent magnet components are located parallel to said bifilar coil central axis and their rotation intersects said coil's core central axis.

3. the motor and generator apparatus of claim 2 wherein;
said rotor has an equal or smaller diameter than said stator.

4. the motor and generator apparatus of claim 3 wherein;
within one or more of said bifilar coils, said first magnetizing coil gauge is different in size from that of said second magnetizing coil gauge.

5. the motor and generator apparatus of claim 4 further comprising;
a controlling circuit electrically connected with one or more of said bifilar coil's first magnetizing coils that receives control command to control the electrical current phases of said first magnetizing coils, driving said rotor to rotate and build up an inertia;
said controlling circuit is also electrically connected with one or more of said bifilar coil's second magnetizing coils and receives the control commands to control and distribute the power detected and received by said second magnetizing coils into electrical power for output; and
said controlling circuit can detect the position of said rotor's rotation and thereby determines and controls the electrical current phase of each of the one or more bifilar magnetizing coils.

6. the motor and generator apparatus of claim 5 wherein;
the electrical power output from said controlling circuit electrically drives either an illuminating unit and/or a storage battery elect.

7. the motor and generator apparatus of claim 6 wherein;
said illuminating unit is a Light Emitting Diode; and
said rotor has one or more fan blades connected to said rotor.

8. the motor and generator apparatus of claim 1 wherein;
within one or more of said bifilar coils, said first magnetizing coil gauge is different in size from that of said second magnetizing coil gauge.

9. the motor and generator apparatus of claim 8 wherein;
said rotor is disc shaped;
said permanent magnet components are located parallel to said bifilar coil central axis and their rotation intersects said coil's core central axis.

10. the motor and generator apparatus of claim 9 wherein;
said rotor has an equal or smaller diameter than said stator.

11. the motor and generator apparatus of claim 10 wherein;
within one or more of said bifilar coils, said first magnetizing coil gauge is different in size from that of said second magnetizing coil gauge.

12. the motor and generator apparatus of claim 11 further comprising;
a controlling circuit electrically connected with one or more of said bifilar coil's first magnetizing coils that receives control command to control the electrical current phases of said first magnetizing coils, driving said rotor to rotate and build up an inertia;
said controlling circuit is also electrically connected with one or more of said bifilar coil's second magnetizing coils and receives the control commands to control and distribute the power detected and received by said second magnetizing coils into electrical power for output; and
said controlling circuit can detect the position of said rotor's rotation and thereby determines and controls the electrical current phase of each of the one or more bifilar magnetizing coils.

13. the motor and generator apparatus of claim 12 wherein;
the electrical power output from said controlling circuit electrically drives either an illuminating unit and/or a storage battery elect.

14. the motor and generator apparatus of claim 13 wherein;
said illuminating unit is a Light Emitting Diode; and
said rotor has one or more fan blades connected to said rotor.

15. the motor and generator apparatus of claim 2 wherein;
within one or more of said bifilar coils, said first magnetizing coil gauge is different in size from that of said second magnetizing coil gauge.

16. the motor and generator apparatus of claim 15 wherein;
said rotor has an equal or smaller diameter than said stator.

17. the motor and generator apparatus of claim 16 wherein;
within one or more of said bifilar coils, said first magnetizing coil gauge is different in size from that of said second magnetizing coil gauge.

18. the motor and generator apparatus of claim 13 further comprising;
a controlling circuit electrically connected with one or more of said bifilar coil's first magnetizing coils that receives control command to control the electrical current phases of said first magnetizing coils, driving said rotor to rotate and build up an inertia;
said controlling circuit is also electrically connected with one or more of said bifilar coil's second magnetizing coils and receives the control commands to control and distribute the power detected and received by said second magnetizing coils into electrical power for output; and
said controlling circuit can detect the position of said rotor's rotation and thereby determines and controls the electrical current phase of each of the one or more bifilar magnetizing coils.

19. the motor and generator apparatus of claim 18 wherein;
the electrical power output from said controlling circuit electrically drives either an illuminating unit and/or a storage battery elect.

20. the motor and generator apparatus of claim 19 wherein;
said illuminating unit is a Light Emitting Diode; and
said rotor has one or more fan blades connected to said rotor.
